(19) United States
(12) Patent Application Publication
(10) Pub. No.: US 2017/0146156 A1
(43) Pub. Date: May 25, 2017

(54) SYSTEM AND METHOD FOR VERTICAL PIPING SUSPENSION

(71) Applicant: Alleghany Capital Corporation, New York, NY (US)

(72) Inventors: Jonathan RICHTER, Golden, CO (US); Harold GAMMAGE, Westminister, CO (US); Drew MATHIES, Lakewood, CO (US)

(21) Appl. No.: 15/358,109

(22) Filed: Nov. 21, 2016

Related U.S. Application Data
(60) Provisional application No. 62/258,083, filed on Nov. 20, 2015.

(51) Int. Cl. F16L 3/223; F16L 5/00; E21F 17/02; F16L 3/12

(52) U.S. Cl. CPC F16L 3/223; F16L 3/12; F16L 5/00; E21F 17/02

(57) ABSTRACT

Disclosed is a system and method for providing a steel structural support to bear the weight of one and/or multiple vertical pipe runs traveling down an extended length vertical shaft. The low profile support of the present invention requires minimal space for attachment inside the diameter of the shaft allowing for maximum space to accommodate hoisting and bulky lifts within the shafts. The system provides the means for supporting vertical pipe runs without the need for additional load bearing strapping or supports within the length of the shaft, further allowing for maximum clearance within the shaft and at the shaft collar.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### CROSS-REFERENCE TO RELATED APPLICATIONS

N/A.

### TECHNICAL FIELD

The present disclosure relates in general to the field of structural support in subterranean environments. In particular, the present disclosure relates to a hanger system for piping and instrumentation support for vertical runs of materials such as fluids, gases and slurries.

### STATEMENT OF FEDERALLY FUNDED RESEARCH

None.

### BACKGROUND OF THE DISCLOSURE

The hanging of piping or cable within mine shafts has always been a problem from the standpoint of convenience, safety, speed of installation and access during such support. Previously, little if any significant advances were made in such fundamental areas as mine configuration (e.g., tunnel or gallery layout and design) techniques specially adapted to meet the needs and requirements of modern, large diameter mine shafts.

Underground mines which utilize vertical shafts to provide access to underground workings typically utilize wood timbers, rails, or structural tubing rigidly anchored to the shaft walls at intervals in order to provide support for piping and instrumentation. More particularly, the guide timbers or rails are fixed to framing fixed horizontally to the shaft wall. These support features have been used in connection with a mine headframe which supports and hangs piping, instrumentation and conveyances.

However, advances in utilizing mining techniques, such as for utilization of subterranean oil recovery platforms for enhanced oil recovery, have necessitated the need for improved structural integrity of mines and the equipment used. It is therefore a critical need to efficiently ensure piping, cables, and instrumentation are effectively suspended while ensuring the most access to the shaft diameter for access by workers and equipment.

### SUMMARY OF THE DISCLOSURE

The present invention presents a new system and method of stabilizing and supporting weight for the vertical suspension of piping over a much longer distance than is normal, including distances greater than 20 feet. A steel structural support to bear the weight of one and/or multiple vertical pipe runs traveling down an extended length vertical shaft. The present invention comprises a low profile support requiring minimal space for attachment inside the diameter of the shaft allowing for maximum space to accommodate hoist personnel and equipment baskets.

There are currently no solutions available that provides piping support which allows for utility piping to transit long extended vertical distances without being secured to the neighboring structure (i.e. the pipes are floating). There may be strapping provided for pipe linearity maintenance but such strapping cannot provide any weight bearing in the vertical plane. This support system is accomplished by anchoring the pipes to piers located on the surface that transfer weight to the shaft collar. This allows multiple utility pipes to travel down a shaft in an unobtrusive manner allowing for maximum space usage of the shaft for other uses such as hoisting or winching bulky loads. The present invention provides a pipe chase/piping capability for long vertical runs of material such as fluids, gases, or slurries. The present invention may further be utilized for ventilation shafts associated with mining operations, as well as heavy civil projects such as subways or vehicle tunnels requiring piping support.

It is therefore an object of the present disclosure to provide a vertical pipe support for a shaft comprising an arc-shaped suspension beam following the curvature of a shaft collar; one or more support beams cantilevered from the arc-shaped beam, wherein said support beams are affixed to a pier assembly such that a majority of the weight of the vertical pipe support is placed upon the shaft collar.

The arc-shaped beam may be comprised of steel, or hot-dipped galvanized steel. The one or more support beams may be comprised of steel, and may further comprise I-beams or other types of beams known in the art.

It is another object of the present invention to provide a low profile suspension beam for suspending vertical pipe runs, wherein support beams are further anchored to piers beyond the end of the shaft collar pad. The pier is comprised of concrete and may be further reinforced. The arc-shaped suspension beam further comprises one or more holes (or cavities) positioned over the inside diameter of the shaft for housing one or more vertical pipe runs. It is another object of the present invention to provide vertical pipe runs comprising floating pipes.

It is another object of the present invention to provide a method of supporting a vertical piping run, comprising extending a suspension beam over a shaft collar, wherein said suspension beam extends beyond the shaft collar to provide clearance for piping; anchoring said suspension beam to the top of the shaft collar pad; providing one or more support beams to the suspension beam which extend beyond the collar pad; and anchoring the one or more support beams distally from the suspension beam to one or more pier assemblies. One or more holes or cavities may be further provided in the suspension beam for inserting one or more piping assemblies, allowing for inserting one or more piping assemblies into the cavities, which comprise vertical pipe runs.

The suspension beam is then anchored a shaft collar pad, and further having support beams which attach to piers, which may comprise reinforced concrete piers. Anchor bolts may be further utilized to secure the support beams to the pier assemblies, as well as to various anchoring sections of the support beams and shaft collar pad, or of the suspension beam itself.

The advantages of the present invention include having increased clearance within the inner diameter of the shaft by minimizing the profile of the vertical pipe runs. Additionally, the vertical pipe runs do not require additional anchoring or suspension for long shaft distances due to the adequate support provided by the suspension beam anchored to the shaft collar pad, as well as to pier assemblies.

These and other features of the present invention will become readily apparent upon further review of the following specification and figures.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 depicts a preferred embodiment of a vertical shaft piping suspension system of the present invention.

FIG. 2 depicts an upward perspective view of a shaft having an appropriately sized radius, wherein the one or more piping and instrumentation strings are suspended from the top of the shaft.

FIG. 3 depicts an exemplary piping detail view of the piping suspended within the suspension beam of the present invention.

FIG. 4 depicts a top perspective view of the suspension beam having three support beams having respective anchoring to piers.

FIG. 5 depicts a top perspective view of the beam assemblies of the support and suspension beams.

FIG. 6 depicts an exploded side perspective view of the support beam attachment to a pier.

FIG. 7 depicts an exploded side perspective view of a support beam joint over a collar pad anchor assembly.

FIG. 8 depicts an exploded front perspective view of two segments of the suspension beam of the present invention having various fastener and anchoring enhancements.

FIG. 9 depicts an exploded front perspective view of alternative embodiment of the present invention having various fastener and anchoring enhancements adapted to a casing or liner.

FIG. 10 depicts a plan view of steel pipe-suspension disk of an alternative embodiment.

FIG. 11 depicts a load spreader anchoring enhancement for a steel pipe-suspension disk.

FIG. 12 depicts a perspective view of an alternative embodiment adapted to a casing or liner.

### DETAILED DESCRIPTION OF THE DISCLOSURE

While the making and using of various embodiments of the present disclosure are discussed in detail below, it should be appreciated that the present disclosure provides many applicable inventive concepts that can be embodied in a wide variety of specific contexts. The specific embodiments discussed herein are merely illustrative of specific ways to make and use the disclosure and do not delimit the scope of the disclosure.

All publications and patent applications mentioned in the specification are indicative of the level of skill of those skilled in the art to which this disclosure pertains. All publications and patent applications are herein incorporated by reference to the same extent as if each individual publication or patent application was specifically and individually indicated to be incorporated by reference.

The present disclosure will now be described more fully hereinafter with reference to the accompanying figures and drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present invention is described below with reference to block diagrams and operational illustrations of methods and devices.

For the purpose of the present invention, a vertical shaft refers to a shaft which contains an angle requiring stabilization and support to be provided by strapping, hangers, bracings, and the like.

Piping refers to various supply and return capabilities including transmission of fluids, gasses and effluents in multiple directions, such as hydrocarbon production. Piping may also include cable systems and wiring systems for power and data transmission. Piping may be enclosed in protective sheaths or coatings, and may have various lengths.

In one embodiment, the supporting apparatus of the present disclosure is made using commercially available steel and conventional joining techniques. The present invention may employ strengthened materials, such as hot dipped galvanized steel, to ensure longevity in the field. In one embodiment, weight bearing structural steel secured according to American Society of Mechanical Engineers (ASME), and American Welding Society (AWS), and North American Corrosion Engineer (NACE) guidelines are utilized to ensure a safe long lasting component is deployed in the field.

In another embodiment, the present invention utilizes steel suspension beams and support beams, which may be further composed of hot dipped galvanized steel to ensure longevity in the field. At each side of the suspension beam arc there are I-beams cantilevered on either side to a concrete pier, the majority of the weight bearing is at the lip of the shaft. In one embodiment, the suspension beams comprises an appropriately sized steel I-beam. For the purposes of the present invention, other beams may be used, such as C-beams, L-beams, or tubular beam sections. The segments may be arc segments of varying lengths depending on the ability to deliver and handle such segment. In another embodiment, the suspension beam is rolled steel, rolled to the finished shape in consideration of the shaft dimensions.

In another embodiment, the present invention provides a steel structural support to bear the weight of one and/or multiple vertical pipe runs traveling down an extended length vertical shaft. It is a low profile support requiring minimal space for attachment inside the diameter of the shaft allows for maximum space to accommodate hoisting and bulky lifts.

As the system is assembled by highly skilled welding and finishing, dimensions which are not coordinated closely with the intended use of the shaft it will provide physical interference in inhibiting the transference of bulkier loads. The present invention may further require highly skilled labor to ensure welds and finishing are adequately performed, and structural integrity is maintained. The invention is heavy in nature requiring skilled labor and dedicated equipment to ensure it is properly installed and secured in accordance with the one or more embodiments set forth herein.

In another embodiment, the present invention may be applied to ventilation shafts in subway and highway tunnels or municipal planning or other heavy civil projects involving shafts having vertical piping runs.

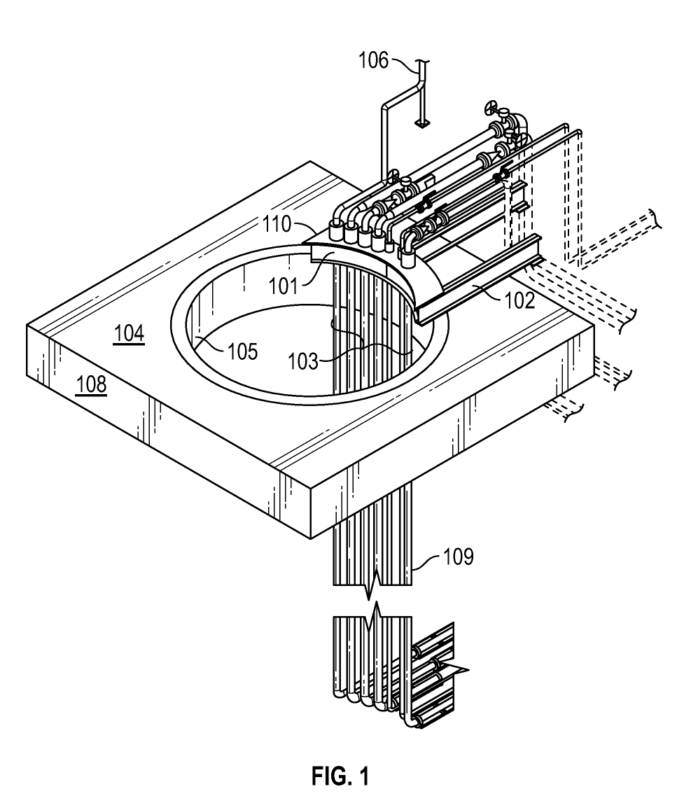

Turning to FIGS. 1-8, illustrative embodiments of an assembled system and method for providing a piping and instrumentation suspension for vertical, or semi-vertical shafts. FIG. 1 presents a preferred embodiment of a vertical shaft piping suspension system comprising a suspension beam 101 shaped to overlap and orient above a shaft collar 105. Support is provided by one or more support beams 102 extending outside the outer border 108 of the shaft collar support 104. Within the suspension beam 101 are comprised one or more pre-measured cavities for insertion of various piping and instrumentation 103. The suspension beam 101 extends over the shaft collar 104 to the minimum amount necessary to provide clearance to the piping 103 to be allowed to extend down the shaft to the desired depth 109. The overlap 110 is minimized, thus allowing for maximized clearance of the remaining shaft for personnel and equipment access without affecting the support necessary for the instrumentation. The one or more support beams 102 extend beyond the shaft collar support 104 in the direction proximal to the suspension beam 101 location over the shaft collar 105 for attachment to anchoring systems, discussed further herein below. The resulting orientation places the majority of the weight of the suspension beam 101 on the shaft collar support 104. The various piping and instrumentation 103 may be further secured or strapped as it proceeds further down the shaft 109, but additional weight support is not needed.

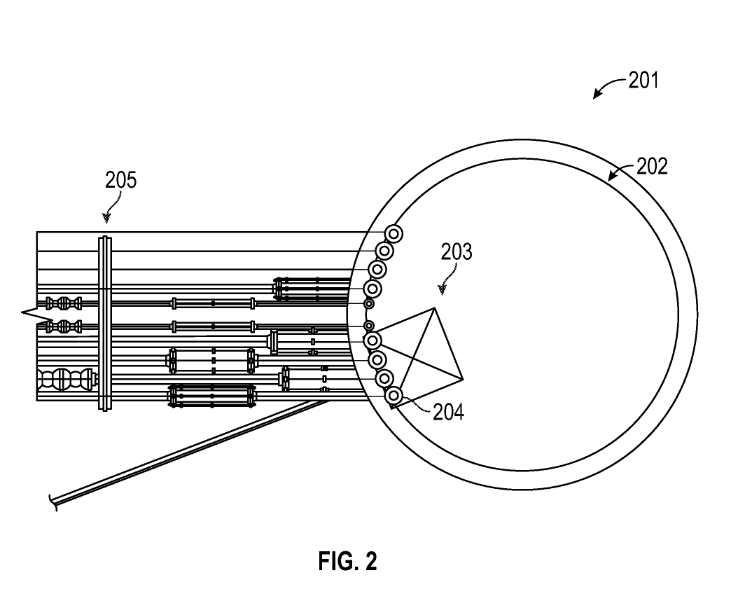

FIG. 2 presents an upward perspective view 201 of a shaft 202 having an internal radius of 8 feet, wherein the one or more piping and instrumentation strings 204 are suspended from the top of the shaft. The piping 204 is then capable of being extended outward in the gallery to the desired locations within the downhole theater. Various hangers and other suspension bracing 205 may be applied in conventional means known in the art. Other applications may include the location of sump pumps 203 or other collection and return configurations.

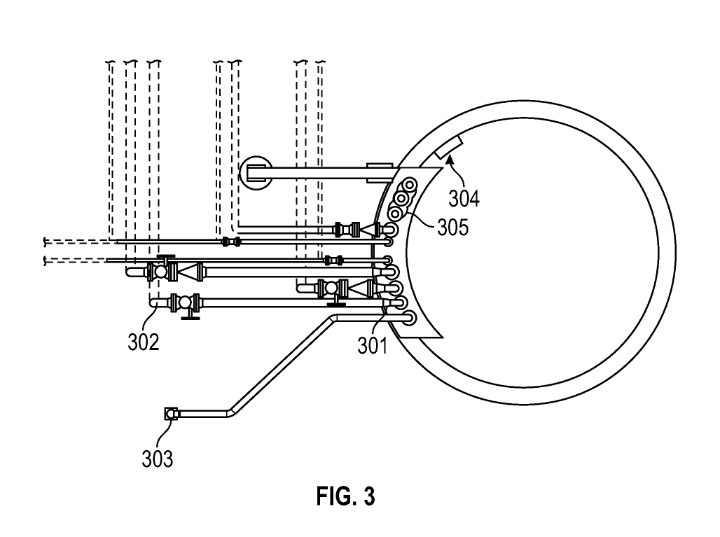

FIG. 3 provides an exemplary piping detail view of the piping suspended within the suspension beam of the present invention. Piping 301 extends upward from its cavity traversing the suspension beam upward and out of the shaft, extending then to one or more junctions 302 which allow for piping to be directed to the various supply or return vesicles or generators. Venting piping 303 may be sent to required distances from the shaft collar. Additional reserve cavities 305 may be pre-formed and left vacant until additional resources are needed or produced down hole. Cable trays 304 may further be affixed at or near the suspension beam.

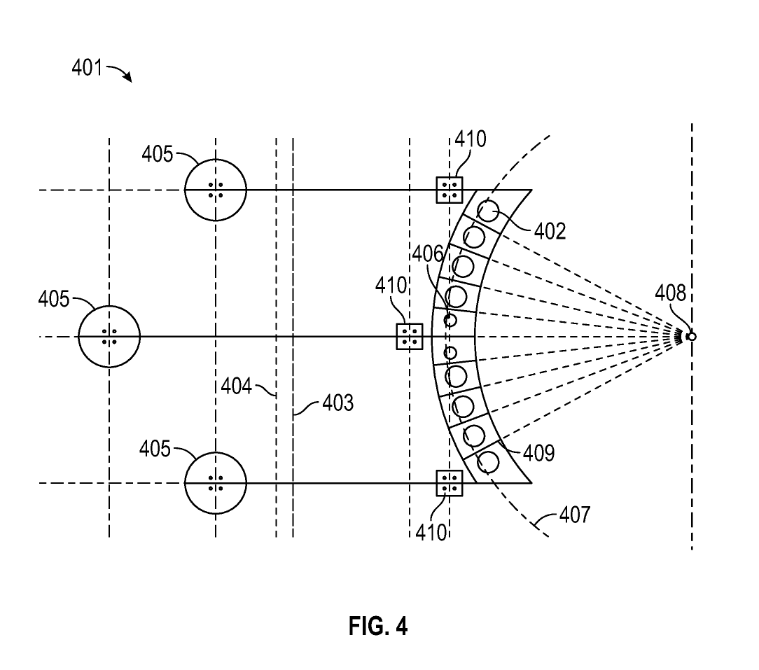

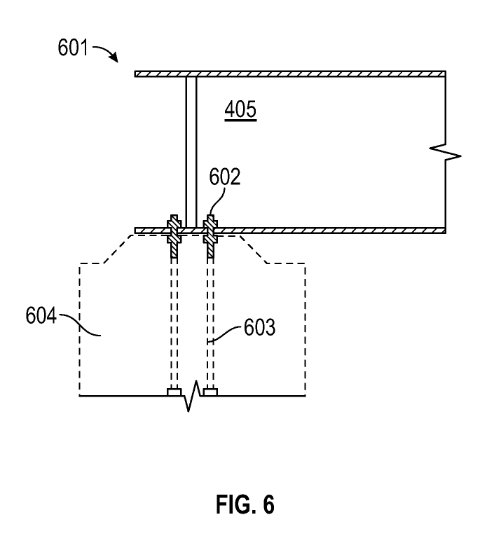

FIG. 4 shows the suspension beam top perspective view 401 having three support beams 405 having respective anchoring to piers (see FIG. 6). The support beams 405 extend beyond the existing collar pad 403 and optional retaining wall 404. The support beams 405 are provided additionally supported by one or more support braces 410 set forth upon the shaft collar pad 403 for anchoring and support to the shaft collar pad. One or more cavities 402 are formed in the suspension beam which extends over the shaft collar 407, suspending the piping down the shaft to the bottom of the shaft 408, including cavities of various sizes 402, 406 for various piping and application, such as for wellhead casings of varying sizes. Stiffeners 409 may be inserted or hung in between the one or more piping cavities.

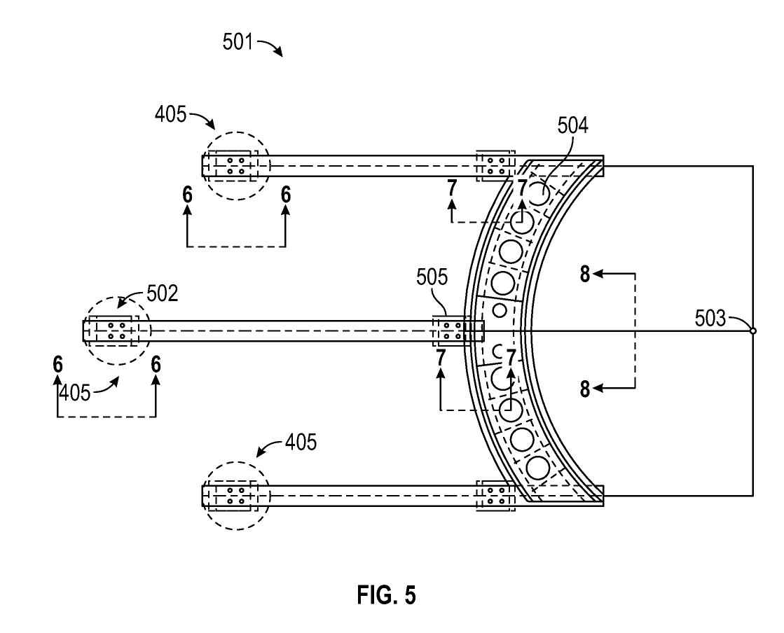

FIGS. 5-8 provide varying perspective views of the suspension beam 503 and support beam 405 assembly of the present invention. FIG. 5 shows a top perspective view 501 of the suspension beam 503 and one or more support beams 405—for exemplary purposes of FIG. 5, three support beams 405 are shown. The support beams may be initially anchored to the collar pad 505. The support beams 405 terminate distally from the suspension beam 503 at piers where the support beams 405 are anchored thereto (see FIG. 6). Within the suspension beam contains one or more cavities 504 for housing the piping assemblies for suspension and transfer down hole. FIG. 5 also provides indications of FIGS. 6-8 and the orientation of the respective views.

FIG. 6 presents a side perspective view of an exemplary anchoring system 601 of the support beam 405 of the present invention. The support beam 405 extends over a pier assembly 604, which may comprise concrete, metal or a combination thereto, including in reinforced configurations. The pier assembly may further comprise vertical reinforcement bars 603 and/or circumference reinforcement bars. The top surface of the pier assembly 604 may be shimmed or grouted, or both, as may be needed. Anchor rods may then be inserted to fasten the support beam 405 to the pier assembly 604. The anchor rods may be further secured by one or more anchor bolts. In another embodiment, at least four (4) anchor bolts are utilized to secure the support beam 405 to the pier assembly 604.

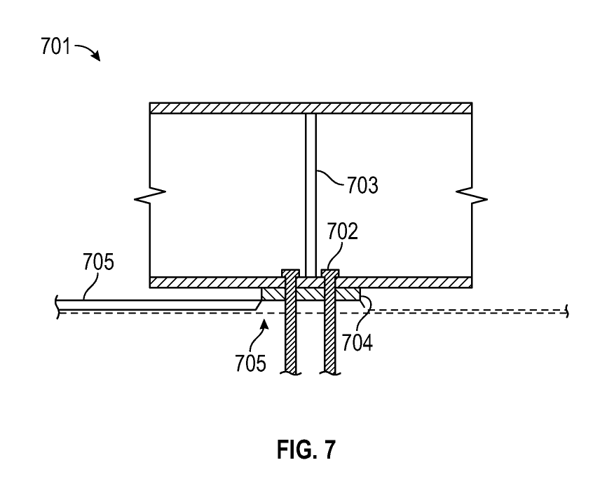

FIG. 7 presents a side perspective view 701 of an anchoring attachment to the top of the collar pad 705. Joints 703 are positions above the center of the anchor, wherein anchor bolts or other fastening devices 704 are utilized to attach both applicable beams to the anchor. The anchor bolts 704 may further include one or more enhancements, such as epoxies or grout layers.

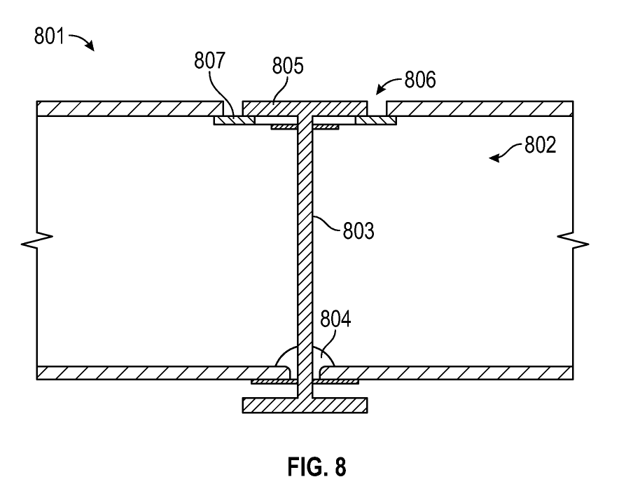

FIG. 8 provides an exploded front perspective view 801 of a joint within the suspension beam 802, wherein various welds 805 and back up bars 806, 807 may be utilized to strengthen such joint 803. Additional anchoring systems 804 may be further employed to support the joint of the suspension beam 802 over the shaft collar or pad.

In one nonlimiting embodiment a vertical pipe support for a shaft comprises an an arc-shaped suspension beam following the curvature of a shaft collar with one or more support beams cantilevered from the arc-shaped beam such that the support beams are affixed to a pier assembly so that a majority of the weight of the vertical pipe support is placed upon the shaft collar.

In other aspects, the arc-shaped beam may be is comprised of steel and may also comprise hot-dipped galvanized steel. Also, the support beams may be comprised of steel. The support beams may be I-beams. The pier may be concrete piers. The arc-shaped suspension may have one or more holes or cavities position over the inside diameter of the shaft for housing one or vertical pipe runs, which pipe runs also may be floating pipes. The arc-shaped suspension beam may have one or more stiffeners in between the one or more holes positioned over the inside diameter of the shaft for housing one or more vertical pipe runs.

In another nonlimiting embodiment a method of supporting a vertical piping run is provided, including extending a suspension beam over a shaft collar, wherein the suspension beam extends beyond the shaft collar to provide clearance for piping, the suspension beam is anchored to the top of the shaft collar pad, one or more support beams are provided to the suspension beam which extend beyond the collar pad and the one or more support beams are anchoring distally from the suspension beam to one or more pier assemblies.

In other aspect, the method includes one or more piping cavities in the suspension beam for inserting one or more piping assemblies. One or more piping assemblies may be inserted into the piping cavities. Vertical pipe runs may be suspended from the piping cavities. The suspension beam may be anchored to a shaft collar pad. The method may include at least three support beams. The pier assemblies may be reinforced concrete piers. Anchor bolts may secure the support beams to the pier assemblies. Stiffeners may be placed in between the one or more piping cavities or holes.

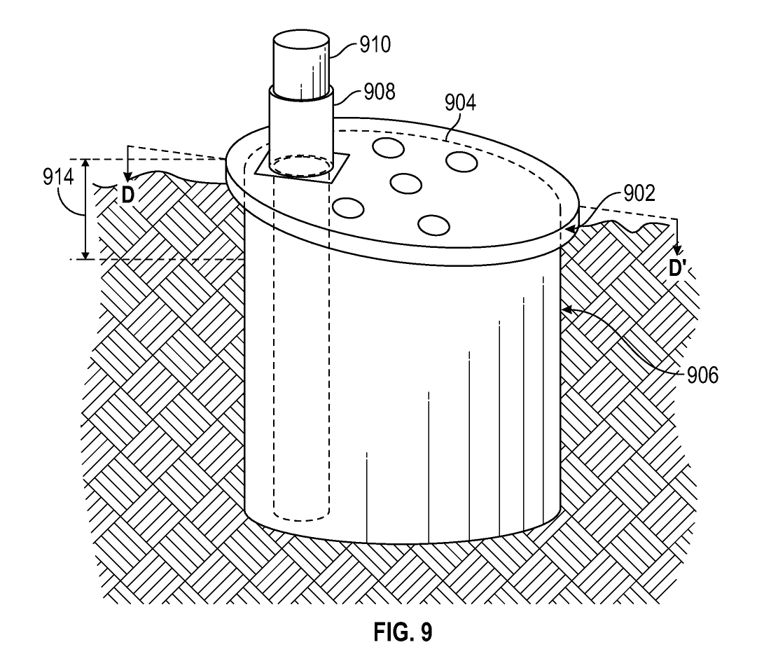

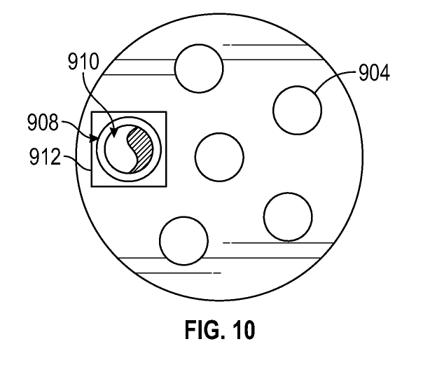

FIG. 9 depicts an exploded front perspective view of alternative embodiment of the present invention having various fastener and anchoring enhancements adapted to a casing or liner. A steel pipe-suspension disk 902 sits atop a casing or liner 906. The steel pipe-suspension disk 902 has piping cavities 904 to allow the passage of piping assemblies. The casing or liner may extend from the surface of the earth 914 by 1 foot or some other arbitrary amount. Vertical pipe 910 may be attached to a pipe coupler 908, where the pipe coupler is attached to load spreader 912 (FIGS. 10, 11, 12) that is in contact with the steel pipe-suspension disk 902.

FIG. 10 depicts a plan view, not to scale, of the steel pipe-suspension disk 902 of an alternative embodiment. The disk may have, as an example, eight cavities for the passage of piping assemblies, though six are illustrated here. The openings may be 2 inches, or they may be 2.05 inches, or any other diameter to allow pipe passage depending on the equipment to be deployed. As illustrated here, a load spreader is attached to the disk. The entire weight of the pipe string 910 is distributed to the steel pipe-suspension disk 902 (also called a “strongback”) at the coupling/spreader point (908/912).

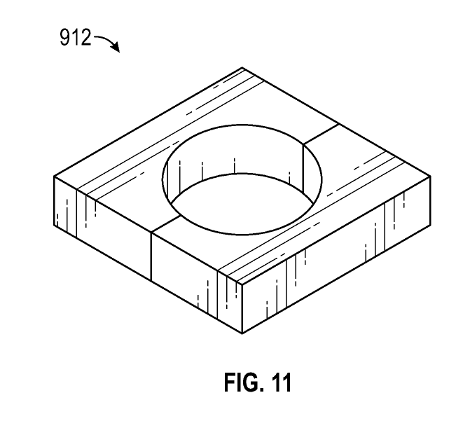

FIG. 11 depicts a detail of possible load spreader anchoring enhancement for a steel pipe-suspension disk. The dimensions as shown are examples and of course will change depending on the equipment being deployed.

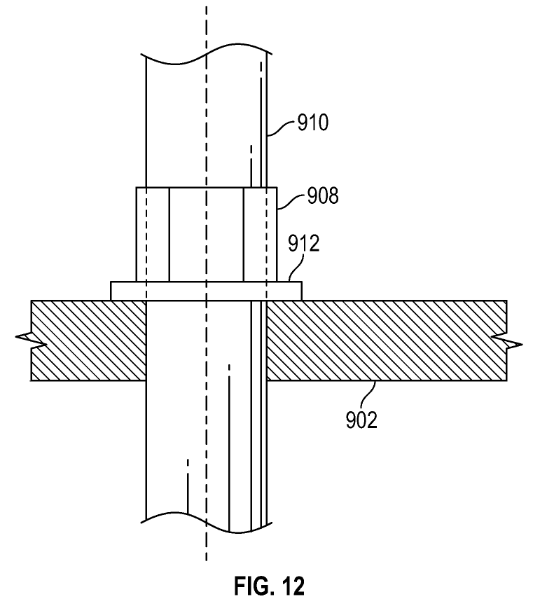

FIG. 12 depicts a perspective view of an alternative embodiment adapted to a casing or liner. The steel pipe-suspension disk 902 is illustrated in relation to the load spreader 912 attached to the steel pipe-suspension disk 902 and attached to the pipe coupler 908 for supporting the pipe 910.

In summary for the various embodiments illustrated in FIGS. 9-12, the strongback, the steel pipe-suspension disk 902 sets atop sets atop the casing and is held in by the weight of the assembly, but can be further secured by tack welding or bolting to the casing. The coupled pipe 910 is positioned on the strongback 902 at coupling 908 atop a plate of steel called a spreader 912. The entire weight of the pipe string 910 is distributed to the strongback 902 at the coupling 908/spreader 912 point.

The pipe 910 is held in place at the strongback 902 by having the radius of spreader 912 opening, and the hole in the strongback at a slightly larger (0.05″) diameter than the o.d. of the pipe with the coupling picking up the weight.

The pipe 910 below the coupling 908 is “smoothbore” or internally threaded which allows the pipe string to be lowered through the strongback during assembly as smoothbore pipe outside diameter is less than that of the pipe hole 904 opening.

In one nonlimiting embodiment a pipe support apparatus for a vertical shaft is provided which comprises a steel pipe-suspension disk, or strongback, with a plurality of cavities for inserting one or more piping assemblies and one or more pipe couplings for at least one of the plurality of cavities and a load spreader atop the steel pipe-suspension disk adapted to couple the pipe coupling to the disk at least one of the plurality of cavities.

In other aspects, the steel pipe-suspension disk is comprised of steel, which also may be hot-dipped galvanized steel. The load spreader may be comprised of steel, which may be hot-dipped galvanized steel. The casing below the steel pipe-suspension disk is a larger diameter than the casing. The steel pipe-suspension disk may be attached to the casing by a tack weld, bolts or set in place. The casing may be cemented in place. As an example, the steel pipe-suspension disk may have a diameter of 2 feet and 3 inches and the casing may have a diameter of 2 feet. The pipe coupling may be a threaded pipe coupling.

In another nonlimiting embodiment, a method of supporting vertical piping runs is provided that comprises extending a steel pipe-suspension disk over a casing, wherein steel pipe-suspension disk extends beyond the casing diameter to provide support, one or more load spreaders are provided at one or more cavities in the disk and one or more pipe couplings are anchored to the one or more load spreaders.

In other aspects, the method provides that one or more piping cavities are present in the steel pipe-suspension disk for inserting one or more piping assemblies. One or more piping assemblies may be inserted into the piping cavities. Vertical pipe runs may be suspended from the piping cavities, the vertical pipe runs attached to the one or more pipe couplings. The pipe couplings may be threaded pipe couplings. The vertical pipe below the coupling may be a smoothbore pipe. The strongback, or steel pipe-suspension disk, may have at least eight cavities. The steel pipe-suspension disk is attached to the top of a casing and this attachment may be by tack weld, bolts or set in place. The casing or liner that the steel pipe-suspension disk sits upon may be cemented in place.

Those skilled in the art will recognize that the methods and systems of the present disclosure may be implemented in many manners and as such are not to be limited by the foregoing exemplary embodiments and examples. Furthermore, the embodiments of methods presented and described as figures or charts in this disclosure are provided by way of example in order to provide a more complete understanding of the technology. Disclosed methods are not limited to the operations and logical flow presented herein. Alternative embodiments are contemplated in which the order of the various operations is altered and in which sub-operations described as being part of a larger operation are performed independently. While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A vertical pipe support for a shaft comprising:
a) an arc-shaped suspension beam following the curvature of a shaft collar;
b) one or more support beams cantilevered from the arc-shaped beam, wherein said support beams are affixed to a pier assembly such that a majority of the weight of the vertical pipe support is placed upon the shaft collar.

2. The vertical pipe support of claim 1, wherein said arc-shaped beam is comprised of steel.

3. The vertical pipe support of claim 2, wherein said arc-shaped beam further comprises hot-dipped galvanized steel.

4. The vertical pipe support of claim 1, wherein said one or more support beams are comprised of steel.

5. The vertical pipe support of claim 4, wherein said one or more support beams comprise I-beams.

6. The vertical pipe support of claim 1, wherein said pier is comprised of concrete.

7. The vertical pipe support of claim 1, wherein the arc-shaped suspension beam further comprises one or more holes positioned over the inside diameter of the shaft for housing one or more vertical pipe runs.

8. The vertical pipe support of claim 7, wherein the vertical pipe runs are floating pipes.

9. The vertical pipe support of claim 7, wherein the arc-shaped suspension beam further comprises one or more stiffeners in between the one or more holes positioned over the inside diameter of the shaft for housing one or more vertical pipe runs.

10. A method of supporting a vertical piping run, comprising
a) extending a suspension beam over a shaft collar, wherein said suspension beam extends beyond the shaft collar to provide clearance for piping;
b) anchoring said suspension beam to the top of the shaft collar pad;
c) providing one or more support beams to the suspension beam which extend beyond the collar pad; and
d) anchoring the one or more support beams distally from the suspension beam to one or more pier assemblies.

11. The method of claim 10, wherein one or more piping cavities are further provided in the suspension beam for inserting one or more piping assemblies.

12. The method of claim 11, further comprising inserting one or more piping assemblies into the piping cavities.

13. The method of claim 12, further comprising suspending vertical pipe runs from the piping cavities.

14. The method of claim 10, further comprising anchoring the suspension beam to a shaft collar pad.

15. The method of claim 10, having at least three support beams.

16. The method of claim 10, further comprising providing pier assemblies comprised of reinforced concrete piers.

17. The method of claim 16, further comprising using anchor bolts to secure the support beams to the pier assemblies.

18. The method of claim 10 further comprising stiffeners in between the one or more piping cavities.
